(19) United States
(12) Patent Application Publication
(10) Pub. No.: US 2007/0103918 A1
(43) Pub. Date: May 10, 2007

(54) Laptop with integral lighting device

(76) Inventor: Jui-Ching Lin, Wufeng Hsiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/267,136

(22) Filed: Nov. 7, 2005

(51) Int. Cl. F21S 8/00

(52) U.S. Cl. 362/427

(57) ABSTRACT

A laptop with lighting devices has more than one channels defined respectively in a periphery of a screen of the laptop and more than one lighting devices pivotally received respectively in the channels. Each lighting device has at least one lighting element mounted thereon and connected to an electrical power supply. In use, the lighting devices are pivoted out of the channels to illuminate a keyboard of the laptop. After use, the lighting devices are pivoted back into the channels to maintain the appearance and dimensions of the laptop.

### BACKGROUND OF THF INVENTION

1. Field of the Invention

The present invention relates to a laptop with lighting devices, and more particularly to a laptop on which the lighting devices are integrally mounted.

2. Description of the Related Art

Portable electronic devices, such as personal digital assistants (PDA) and notebook computers, can be carried for use on business trips or taken outdoors for research or fieldwork. However, additional lighting devices are usually required to illuminate the keyboards or keypads of the electronic devices in poor lighting conditions. Conventional lighting devices are available that can be attached to portable electronic devices.

One conventional type of lighting device can be electrically connected to a USB slot of a laptop. Disadvantages of this type of lighting device are described as follows:

1. The lighting device is not an integral part of the laptop, such that a user must carry it in addition to the laptop, which makes it inconvenient.

2. The lighting device is attached in front of the user thereby interfering with the user's view.

Another conventional type of lighting device is integrally provided on a periphery of a cover of a laptop. The device is usually mounted on a rear surface of which the screen is provided, and aimed at the keyboard. However, the device is mounted such that a chassis of a laptop cannot be securely closed with the cover due to the lighting device when not in use thereby increasing the size of the laptop.

Therefore, the invention provides a laptop with lighting devices to mitigate or obviate the aforementioned problems.

### SUMMARY OF THE INVENTION

The main objective of the present invention is to provide a laptop with lighting devices, which can be integrally hidden in a periphery of the screen to provide light and not increase the size of the laptop.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first preferred embodiment of a laptop with lighting devices in accordance with the present invention;

FIG. 2 is a partial exploded perspective view of the first preferred embodiment of the laptop with lighting devices in FIG. 1;

FIG. 3 is a partial operational perspective view of the first preferred embodiment of the laptop with lighting devices in FIG. 1;

FIG. 4 is a partial operational perspective view of a second embodiment of a laptop with lighting devices in accordance with the present invention;

FIG. 5 is a partial perspective view of a third embodiment of a laptop with lighting devices in accordance with the present invention;

FIG. 6 is a perspective view of a fourth embodiment of a laptop with lighting devices in accordance with the present invention; and

FIG. 7 is a partial operational perspective view of the fourth embodiment of the laptop with the lighting devices in FIG. 6.

### DETAILED DESCRIPTION OF THE PREFERRED EMBODIMENT

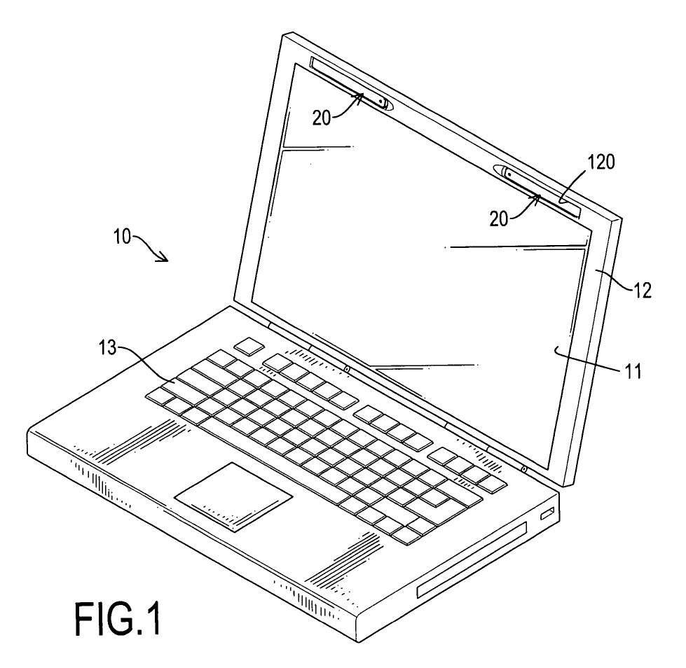

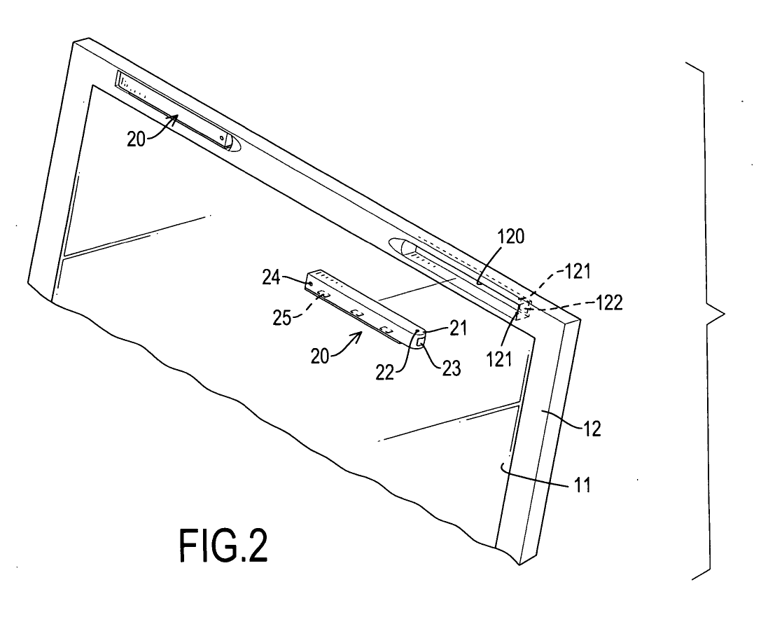

With reference to FIGS. 1 and 2, a first preferred embodiment of a laptop with lighting devices comprises a laptop (10) and two lighting devices (20). The laptop (10) has a screen (11) mounted on a side of a cover thereof and a keyboard (13) mounted on a base pivotally connected to the cover. Two transverse channels (120) are defined in an upper periphery (12) of the screen (11) and each has at least one pivot mounting point (121) at an end thereof. A terminal (122) is mounted at a pivot end of the channel (120) and is connected to an electrical power supply provided by the laptop (10). The lighting devices (20) are received in the transverse channels (120), respectively, so that the lighting devices (20) are integrally mounted in the laptop (10).

The lighting devices (20) have a rectangular cross section and two ends. One end is a pivot end (21) with fasteners (22) formed thereon to engage in the pivot mounting point (121), such that the lighting device (20) can be pivotally and transversely moved out of the channel (120). A contact (23) is mounted on a surface of the pivot end (21) to connect with the terminal (122) when the lighting devices (20) are pivoted out of the channels (120). Lighting elements (25) are mounted respectively on a lower side of the lighting devices (20) and can be LEDs or flat lighting modules. A switch (24) is provided in a distal end of the lighting device (20) and opposite the pivot end (21) to switch the lighting element (25) on or off. Alternatively, an electrical wire is provided in the channel (120) to connect the lighting element (25) to the electrical power directly instead of through the contact (23) and the terminal (122).

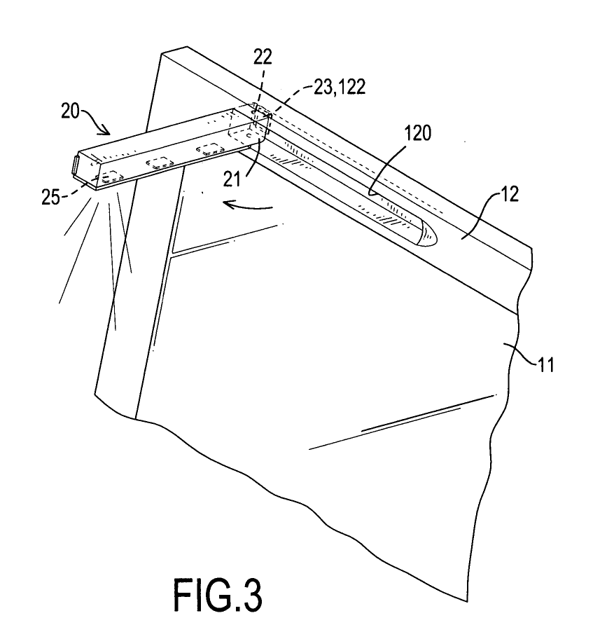

With reference to FIG. 3, as the lighting device (20) is pivotally moved out of the channel (120) for use, at the pivot end (22), the contact (23) becomes electrically connected to the terminal (122). The light device (20) can be turned on and the lighting element (25) used to illuminate the keyboard (13). After use, the lighting devices (20) can be pivoted back into the channels (12) cutting off the electrical power. Hence, the lighting devices (20) can be neatly hidden in the periphery (12) of the screen (11) and the original appearance and dimensions of the laptop can be maintained.

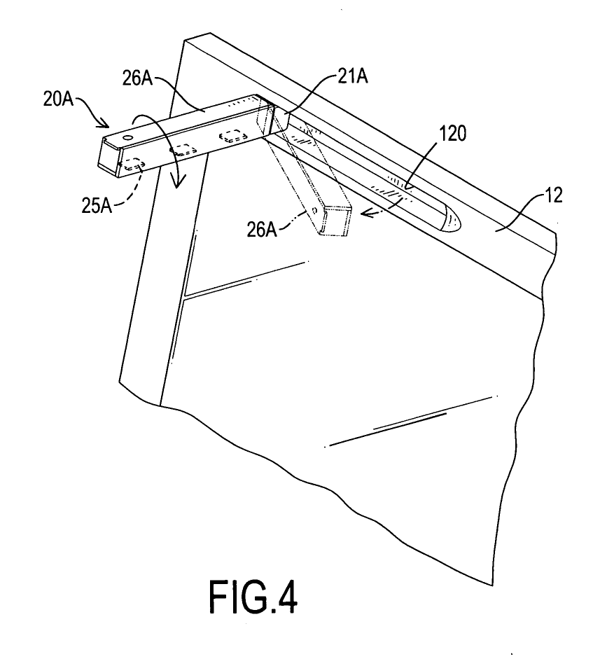

With reference to FIG. 4, a second embodiment of a laptop with lighting devices (20A) is similar to the first preferred embodiment except for the lighting devices (20A). The lighting device (20A) has a pivot end (21A) and a body (26A) rotatably connected to the pivot end (21A). The pivot end (21A) is pivotally connected to the channel (120) and lighting elements (25A) are mounted respectively on a side of the body (26A). When the body (26A) is pulled out of the channel (120) at the pivotal (21A), the body (26A) can be further rotated axially to direct the light to a desired location.

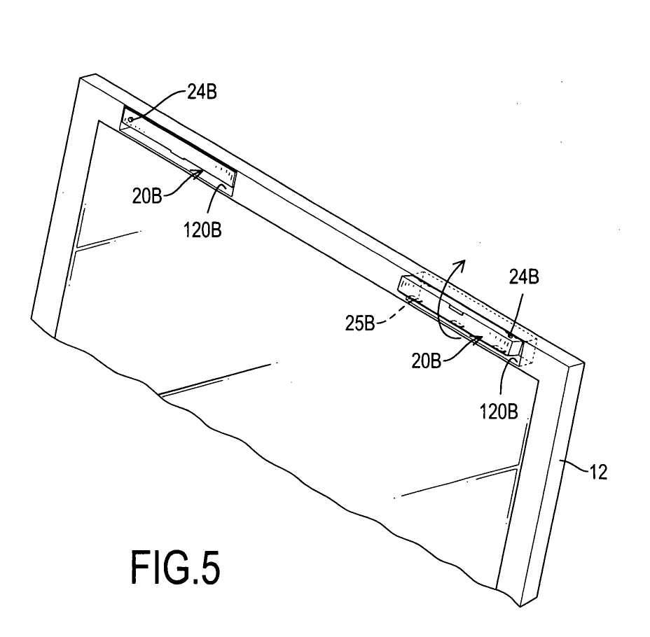

With reference to FIG. 5, a third embodiment of a laptop with lighting devices has a laptop and two lighting devices (20B). Two channels (120B) are respectively provided on an upper periphery of a screen (12) and a terminal (122B) is mounted in the channel (120B). A top edge of the lighting device (20B) is pivotally connected to an upper channel wall and the lighting devices (20A) can be swung upward relative to the channel (120B) and positioned in a desired location. Each lighting device (20B) has a switch (24B) and more than one lighting element (25B). When the lighting devices (20B) are moved out of the channel (120B), the lighting element (25B) can illuminate the keyboard by switching the switch (24B).

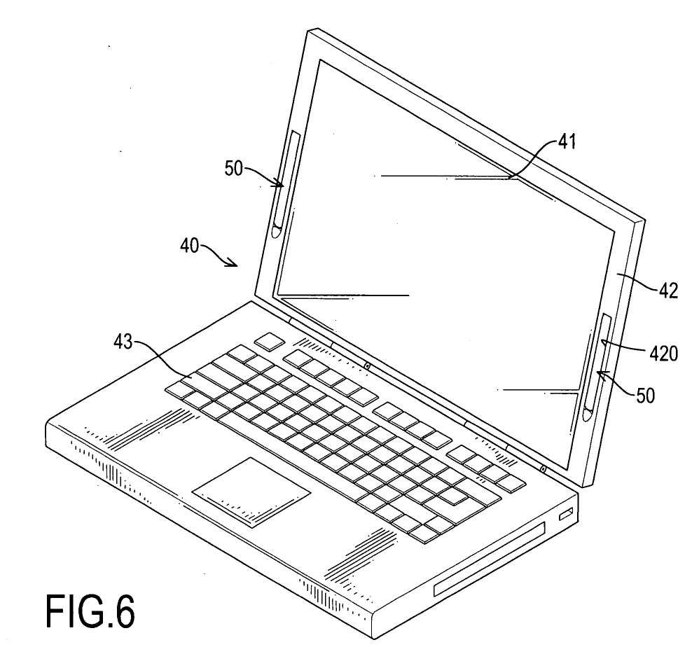

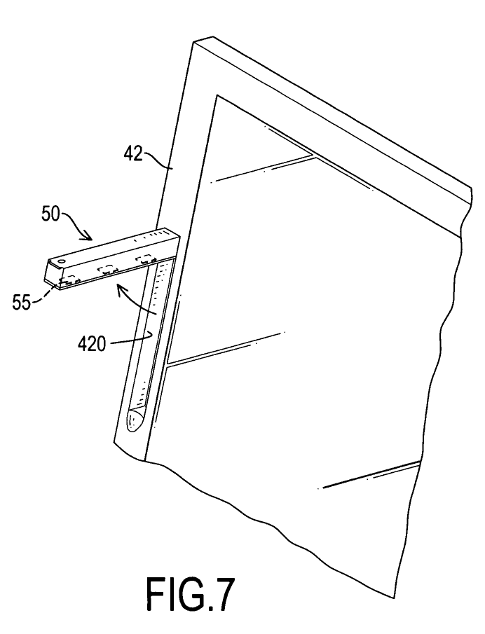

With reference to FIGS. 6 and 7, a fourth embodiment of a laptop with lighting devices is similar to the first preferred embodiment. A laptop (40) has a screen (41) and a keyboard (43). Two channels (420) are defined respectively in a periphery (42) on two sides of the screen (41) and two lighting devices (50) are mounted respectively in the channels (420) to illuminate the keyboard (43).

It is to be understood, however, that even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A laptop with lighting devices comprising:
multiple channels defined respectively in a periphery of a screen of the laptop; and
multiple lighting devices pivotally received respectively into the channels and each having
multiple lighting elements mounted on the lighting device and connected to an electrical power supply.

2. The laptop with lighting devices as claimed in claim 1, wherein the lighting devices each have a pivotal end formed at an end of the lighting device and pivotally connected to a corresponding one of the channels, and a body connected to the pivotal end whereby the body can pivot in or out of the corresponding channel, each channel has multiple first fasteners respectively mounted thereon and the lighting devices each have multiple second fasteners to engage with the first fasteners on the corresponding channel whereby the lighting devices can be mounted in the channels, and the lighting elements are respectively mounted on the body.

3. The laptop with lighting devices as claimed in claim 1, wherein a contact is mounted in a surface of the pivot end of each lighting device and a terminal is mounted in each channel whereby each contact is connected to a corresponding one of the terminals when the lighting devices are pivoted out of the channels.

4. The laptop with lighting devices as claimed in claim 3, wherein a switch is mounted on each lighting device.

5. The laptop with the lighting devices as claimed in claim 3, wherein the lighting elements are flat lighting modules.

6. The laptop with the lighting device as claimed in claim 4, wherein the lighting elements are flat lighting modules.

7. The laptop with the lighting device as claimed in claim 5, wherein the lighting elements are flat lighting modules.
